(19) United States
(12) Patent Application Publication
(10) Pub. No.: US 2019/0320022 A1
(43) Pub. Date: Oct. 17, 2019

(54) QUALITY OF SERVICE KNOBS FOR VISUAL DATA STORAGE

(71) Applicant: Intel Corporation, Santa Clara, CA (US)

(72) Inventors: Arun Raghunath, Portland, OR (US); Christina R. Strong, Hillsboro, OR (US)

(73) Assignee: Intel Corporation, Santa Clara, CA (US)

(21) Appl. No.: 16/452,491

(22) Filed: Jun. 25, 2019

(51) Int. Cl. H04L 29/08; G06F 3/06

(52) U.S. Cl. CPC H04L 67/1097; G06F 3/067; H04L 67/101; G06F 3/064; G06F 3/0626

(57) ABSTRACT

In one embodiment, an apparatus comprises processing circuitry to: receive a request from an application to write an image to a data storage system, the request comprising one or more quality of service parameters indicating a level of service requested by the application; partition the image into a plurality of image parts; upload the plurality of image parts to the data storage system in parallel, wherein if the level of service requested by the application comprises low latency: a plurality of redundant copies of each image part is to be uploaded to the data storage system in parallel; and each image part that fails to upload within an upload timeout threshold is to be re-uploaded to the data storage system; receive an acknowledgment from the data storage system that each image part has been uploaded; and notify the application that the image has been written to the data storage system.

### FIELD OF THE SPECIFICATION

This disclosure relates in general to the field of visual computing, and more particularly, though not exclusively, to quality of service knobs for visual data storage.

### BACKGROUND

A large-scale visual computing application deployed on a distributed computing infrastructure, such as a cloud-based datacenter, often leverages a centralized storage service to share visual data between different processing stages of the application. Storing and retrieving visual data on a centralized storage service may require the visual data to be uploaded to and downloaded from the centralized storage service within the distributed computing infrastructure. These uploads and downloads to and from the centralized storage service must be performed efficiently for a time-sensitive visual computing application, as any delay or variability can impact numerous processing stages. This can be particularly problematic on a shared computing infrastructure, such as a public cloud, as there is typically substantial variability in the access latencies for cloud-based storage services.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of a computing system that leverages quality of service (QoS) knobs for visual data storage.

FIG. 2A illustrates a call flow diagram for an image write operation performed using a multipart upload.

FIG. 2B illustrates a call flow diagram for an image write operation performed using a multipart upload with part retries.

FIG. 2C illustrates a call flow diagram for an image write operation performed using a multipart upload with redundant parallel part tries.

FIG. 2D illustrates a call flow diagram for an image write operation performed using a multipart upload with strong consistency.

FIG. 2E illustrates a call flow diagram for an image write operation performed using a multipart upload with dual completion callbacks to balance consistency and latency.

FIGS. 3A, 3B, and 3C illustrate performance graphs associated with multipart file uploads.

FIG. 4 illustrates an example implementation of an image write operation with configurable quality of service (QoS) parameters.

FIG. 5 illustrates a flowchart for an example embodiment of an image write operation using configurable quality of service (QoS) parameters.

FIGS. 6, 7, 8, and 9 illustrate examples of Internet-of-Things (IoT) networks and architectures that can be used in accordance with certain embodiments.

FIGS. 10 and 11 illustrate example computer architectures that can be used in accordance with certain embodiments.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Quality of Service Knobs for Visual Data Storage

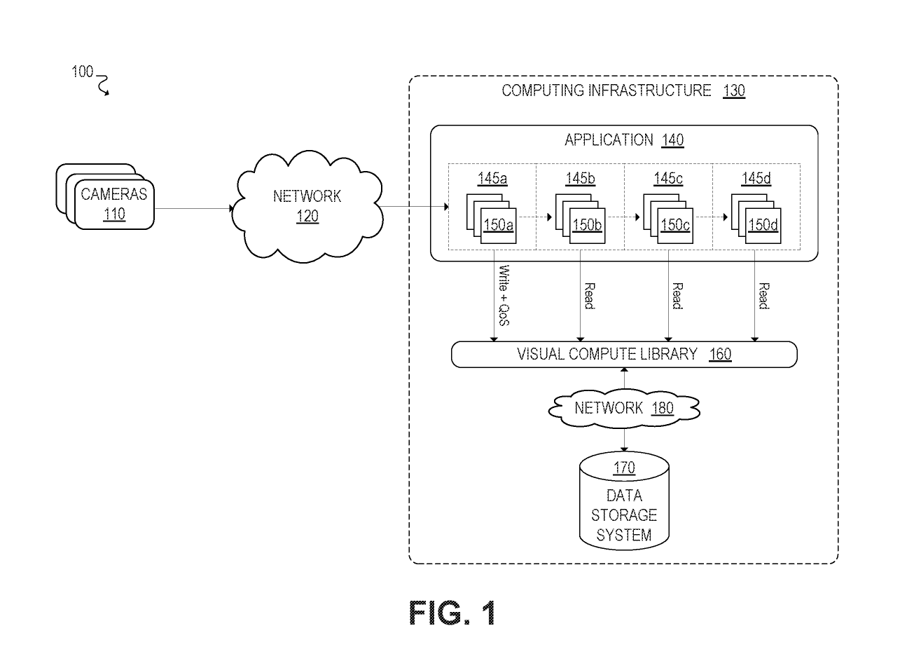

FIG. 1 illustrates an example embodiment of a computing system 100 that leverages quality of service (QoS) knobs for visual data storage. In the illustrated embodiment, for example, visual data captured by cameras 110 is streamed over a network 120 into a distributed computing infrastructure 130. The distributed computing infrastructure 130 may be deployed in the cloud, the edge, and/or anywhere in between in the “fog,” such as a cloud datacenter and/or an on-premise edge datacenter.

Once received, the visual data streams are processed by a visual computing application 140 deployed on the computing infrastructure 130. For example, the visual computing application 140 may include a collection of pipelined processing stages 145a-d, which are parallelized across numerous compute instances 150a-d that are instantiated on the computing infrastructure 130. In some embodiments, for example, the compute instances 150a-d may be virtual machines running on one or more physical machines or compute nodes in the computing infrastructure 130, and each virtual machine may be used to execute software associated with a particular processing stage 145a-d of the application 140 (e.g., Amazon Web Services (AWS) Elastic Compute (EC) instances).

Moreover, a centralized data storage system or service 170 on the computing infrastructure 130 may be leveraged to share visual data among the respective processing stages 145a-d of the application 140 (e.g., to facilitate parallel processing). Thus, storing and retrieving visual data on the centralized storage system 170 may require the visual data to be uploaded and downloaded to and from the centralized storage system 170 (e.g., over a fabric or network 180 within the computing infrastructure 130). These uploads and downloads to and from the centralized storage system 170 must be performed efficiently for a time-sensitive visual computing application 140, as any delay or variability can impact numerous processing stages 145a-d. This can be particularly problematic on a shared computing infrastructure 130, such as a public cloud, as there is typically substantial variability in the access latencies for cloud-based storage services.

Accordingly, in the illustrated embodiment, the application 140 leverages a visual compute library (VCL) 160 to store and retrieve visual data on the centralized data storage system 170 in an efficient manner. In particular, the VCL 160 enables the application 140 to configure various quality of service (QoS) knobs to control the desired level of performance and/or consistency for uploading (e.g., writing) and/or downloading (e.g., reading) visual data to and from the centralized storage system 170, as described further below.

As an example, consider a cloud-based application 140 that generates three-dimensional (3D) renderings and/or replays of sporting events in near real-time (e.g., using Intel True View technology). Numerous high-resolution cameras 110 mounted throughout a sports venue are used to capture high-bandwidth visual data of a sporting event from many different perspectives (e.g., 38-120 cameras in some cases), which is then streamed over a network 120 into a distributed computing infrastructure 130 (e.g., via leased lines from an internet service provider (ISP)), such as a cloud-based datacenter.

Once in the cloud, the visual data streams are processed by the application 140 using a multi-stage pipeline 145a-d, which may be distributed across numerous compute instances 150a-d that are instantiated on the computing infrastructure 130. In the first stage 145a of the pipeline, the visual data streams are decoded into raw frames, and the raw frames are then uploaded and written to a centralized storage system 170 on the computing infrastructure 130 (e.g., a cloud-based data storage service). In the remaining stages 145b-d of the pipeline, the raw frames are retrieved from the centralized storage system 170 and then processed in order to create a 3D model of the sporting action.

The centralized storage system 170 is leveraged to parallelize the individual pipeline stages 145a-d, as individual virtualized compute instances in the cloud are typically not powerful enough to maintain the low-latency processing required at the respective stages of the processing pipeline. Thus, hundreds of compute instances 150a-d may be spawned for each pipeline stage 145a-d, each processing a small cube in the overall 3D space, which can then be stitched back together to create the entire 3D model.

Moving large volumes of visual data between the respective pipeline stages 145a-d can be challenging. For example, the compute instances 150a in the first pipeline stage 145a typically receive and decode the video streams, and then they perform write operations to upload and write the decoded video streams to the centralized storage system 170 (e.g., enabling the decoded video streams to be retrieved from centralized storage 170 by the compute instances 150b-d that perform the subsequent processing stages 145b-d). The uploads associated with these write operations must be performed efficiently—any variability in upload time can be particularly problematic in these circumstances (e.g., for high-bandwidth low-latency streaming data usage), as a slowdown in the upload of even a single frame can impact hundreds of pipeline stages.

In some cases, multipart uploads may be leveraged to improve the efficiency of uploads for write operations within the distributed computing infrastructure 130. A multipart upload may involve uploading multiple related data parts in parallel and then subsequently composing or assembling the uploaded data parts into a single larger data object, such as a file. In some embodiments, for example, multipart uploads may be implemented using HTTP multipart requests (e.g., multipart requests defined by the hypertext transfer protocol (HTTP)). While multipart uploads can improve the efficiency of uploads in some cases, the additional signaling overhead requires multiple roundtrips, which increases the overall upload latency for the uploaded objects (particularly for uploads within a datacenter).

Moreover, when the computing infrastructure 130 is a shared multi-tenant infrastructure in a public cloud, there will typically be substantial variability in the time required to upload the respective parts of a multipart upload. Typically, the network latency overshadows variability in storage write latencies. However, in the context of uploading and writing data from within a datacenter (e.g., within computing infrastructure 130, from a compute instance 150a-d to centralized storage 170), the variability in write latency matters.

For example, as a consequence of being shared infrastructure 130, often one of the parts of the multipart upload takes orders of magnitude more time to upload than others. In such cases, the entire object upload is delayed until the slowest part is uploaded. This is particularly problematic when a stream of images is being uploaded, as the pipeline stages 145a-d that are delayed due to a slow upload do not have time to catch up when new data is constantly being added.

Currently, this problem is addressed by overprovisioning or pre-spawning a large number of compute instances 150a-d on the computing infrastructure 130 so that any slowdown of the upload is offset by tasking more compute instances to process smaller subsets of the 3D space, thereby lowering the processing latency. This approach is very expensive, however, particularly when the pre-spawned compute instances are underutilized.

Another consequence of using a shared computing infrastructure 130 relates to the level of consistency offered for write operations (e.g., uploading and writing data within the shared infrastructure 130 to centralized storage 170, as described above). For scalability, most public cloud storage services offer “eventual consistency” for write operations, such that after new data is uploaded and written to storage 170, there exists a window of time when subsequent read requests might still see the old data. As a result, a visual computing application 140 must account for eventual consistency guarantees in its processing logic to ensure correctness of its overall operation.

Accordingly, in the illustrated embodiment, the application 140 leverages a visual compute library (VCL) 160 to store and retrieve visual data on the computing infrastructure 130 in an efficient manner. In particular, the VCL 160 is a software library designed to interface with visual data on behalf of the application 140, which may include converting visual data into machine-friendly formats for faster retrieval and/or analysis (e.g., by partitioning visual data into smaller pieces to enable sub-areas of the visual data to be retrieved faster), writing visual data to the underlying storage system, reading visual data from the underlying storage system, and so forth.

For example, when performing write operations on behalf of the application 140, the VCL 160 is responsible for writing visual data to the underlying storage system in an efficient manner, whether the storage system is local or remote. Thus, for a write operation to a remote storage device 170 (e.g., centralized storage in the cloud), the VCL 160 may allow the application 140 to configure various quality of service (QoS) knobs to control the desired level of performance and/or consistency for the write operation.

In general, a knob may include any mechanism that enables some aspect of a particular task or operation to be configured, controlled, adjusted, and/or otherwise influenced in some manner, such as based on the preferences of a particular entity, application, user, and/or use case. For example, with respect to an image write operation, a quality of service (QoS) knob may include a configurable parameter that influences the behavior of the operation based on one or more performance preferences, such as a desired latency, bandwidth (e.g., throughput), and/or write consistency level, among other examples. In some embodiments, for example, an image write operation may be implemented using one or more quality of service (QoS) knobs that can be configured to favor certain performance metrics (e.g., latency or bandwidth) and/or provide different levels of write consistency when uploading and writing visual data to the remote storage device 170. Similar mechanisms can also be used to perform read operations on behalf of the application 140 (e.g., downloading/reading visual data from the underlying storage system).

In this manner, the application 140 has the flexibility to specify which performance parameters (e.g., latency or throughput, write consistency levels) are the most important for purposes of uploading and writing visual data to the centralized storage system 170 (e.g., a public cloud storage service). The VCL 160 can then internally modify how the visual data (e.g., images, video frames) is uploaded to the storage system 170 in order to maximize the performance preferences of the application 140, thus decreasing the variability in upload and write latency to the shared storage system 170.

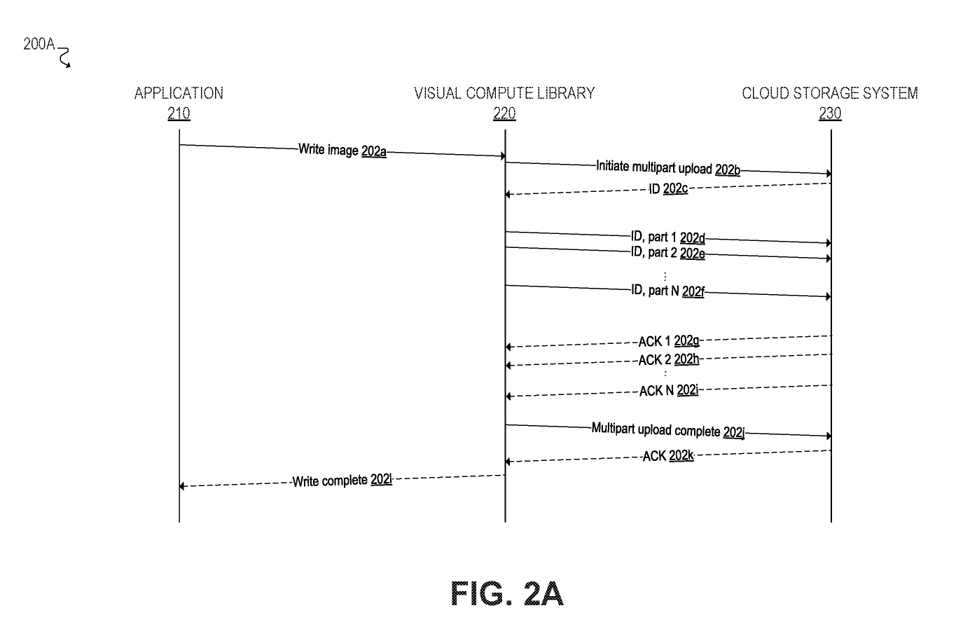

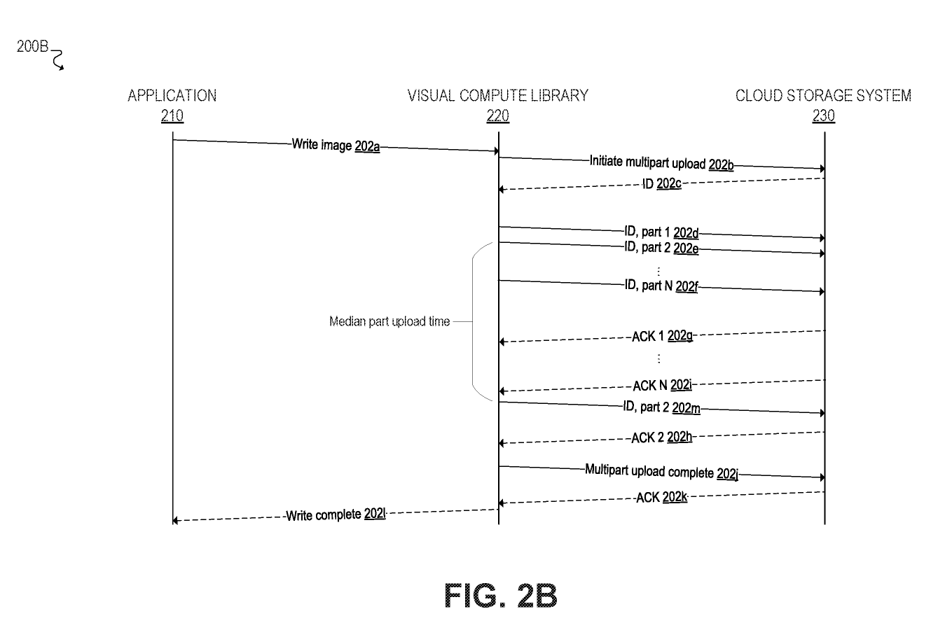

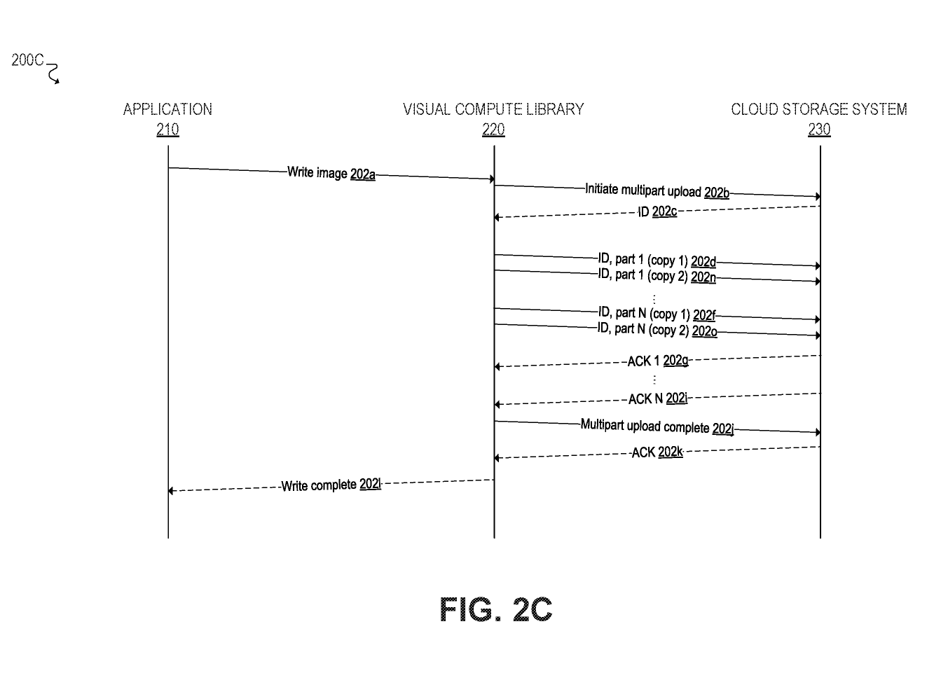

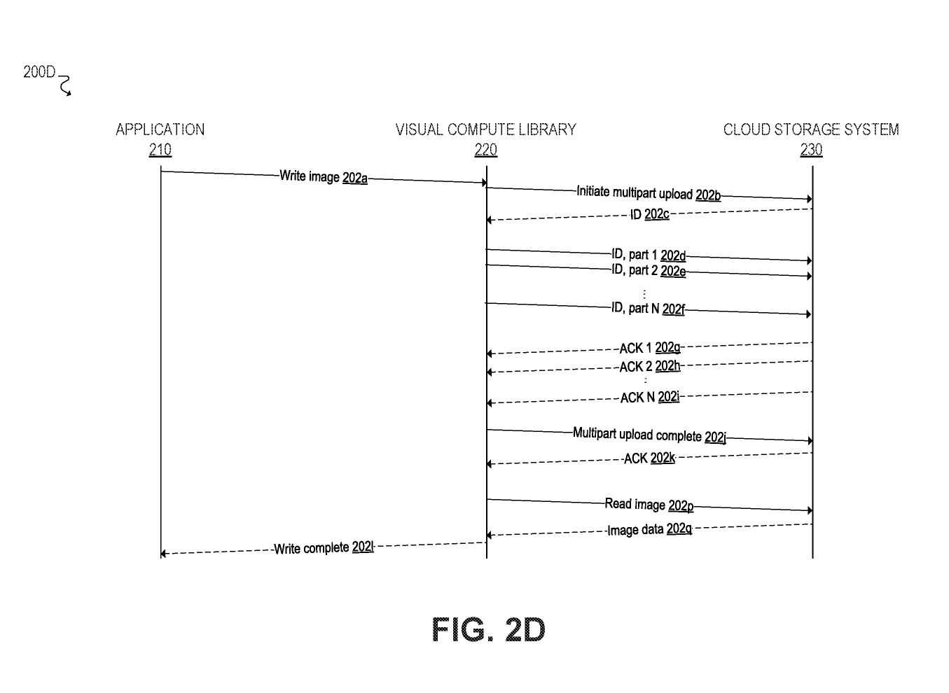

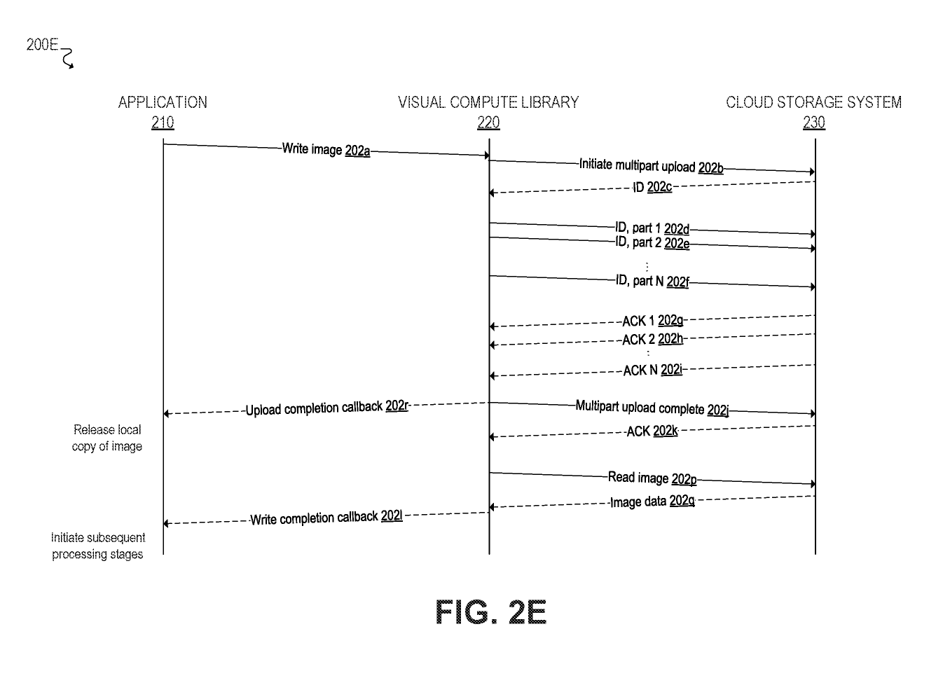

In some embodiments, for example, the application 140 may specify QoS knobs relating to the desired latency (e.g., low, high) and/or write consistency (e.g., weak, strong) for a write operation to a centralized storage system 170. Moreover, based on the QoS knobs configured by the application 140, the VCL 160 may upload and write the visual data using a combination of multipart uploads, part upload retries, redundant parallel part uploads, guaranteed consistency callbacks, and/or dual-consistency callbacks, as described further below in connection with FIGS. 2A-E.

The core of this solution is in improving an application's chosen metric of interest (e.g., latency or throughput) by compensating other performance metrics when storing visual data in a public cloud service. Moreover, this solution can be applied to any cloud storage system or service (e.g., by extending the VCL to support the preferred service), such as Amazon Web Services (AWS) Simple Storage Service (S3) and/or Elastic File System (EFS), Microsoft Azure Blob Storage, and/or Google Cloud Storage, among other examples.

This solution provides numerous advantages. For example, cloud deployment of a large-scale visual computing application (e.g., an application that leverages Intel True View technology) typically requires custom-built pipeline stages for parallelizing image uploads into centralized storage, as well as overprovisioning resources for numerous downstream application stages via pre-spawned compute instances.

The described solution provides lower and more predictable upload latency, which allows the number of pre-spawned compute instances to be reduced, thus reducing the cost of cloud deployment significantly. Furthermore, this solution simplifies the overall pipeline management required for transferring data between different application stages. Eliminating the need for application logic to deal with storage service variabilities (e.g., pre-spawning extra compute instances to offset storage variabilities, managing assignment of compute instances to application processing stages) removes a big source of complexity in the overall application deployment.

More broadly, this solution reduces variability in upload latencies when using public cloud storage services for high-bandwidth streaming uploads, which ultimately translates to lower total cost of ownership (TCO) for a broad variety of solutions that require visual processing in the cloud.

This solution also provides the flexibility for client applications to trade one metric over another (e.g., latency vs. bandwidth) in order to perform uploads efficiently (e.g., based on the desired metric) even when using a shared storage system or service.

Moreover, the described solution is applicable to any applications or use cases that leverage remote data storage (e.g., centralized, distributed, and/or networked data storage systems) for storing any type of visual data, including images, videos, and/or other representations of visual data (e.g., processed or summarized visual data, such as visual metadata or feature vectors), having any number of dimensions (e.g., one-dimensional (1D), two-dimensional (2D), three-dimensional (3D), or N-dimensional visual data, such as images, videos, or feature vectors), captured and/or generated using cameras, vision sensors, medical or industrial imaging systems (e.g., X-ray machines, magnetic resonance imaging (MRI) scanners), augmented reality (AR) and/or virtual reality (VR) systems, and/or any other type of imaging or visual processing systems.

Additional functionality and embodiments are described further in connection with the remaining FIGURES. Accordingly, it should be appreciated that computing system 100 of FIG. 1 may be implemented with any aspects of the embodiments described throughout this disclosure.

FIGS. 2A-E illustrate various call flow diagrams for an image write operation implemented by a visual compute library. In particular, the image write operation is used to upload and write an image or other visual data from an application 210 to a cloud storage system or service 230 using a visual compute library (VCL) 220. In some embodiments, for example, some or all aspects of the image write operation of FIGS. 2A-E may be implemented by visual compute library 160 of FIG. 1 to upload and write an image or other visual data from application 140 to data storage system 170.

FIG. 2A illustrates a call flow diagram 200A for an image write operation performed using a multipart upload. In some cases, for example, the VCL 220 may leverage a multipart upload to upload an image with a large size to the cloud storage system 230 more efficiently. A multipart upload may involve uploading multiple related data parts in parallel and then subsequently composing or assembling the uploaded data parts into a single larger data object, such as a file or image. In some embodiments, for example, a multipart upload may be implemented using an HTTP multipart request.

In the illustrated call flow, for example, the application 210 sends a write image request 202a to the VCL 220, and in turn, the VCL 220 sends an initiate multipart upload request 202b to the cloud storage system 230. The cloud storage system 230 then responds with an upload identifier (ID) 202c for the VCL 220 to use to identify part uploads that are associated with this multipart upload. The VCL 220 then uploads each part 202d,e,f of the multipart upload (e.g., part 1, part 2, . . . part N) to the cloud storage system 230 in parallel, where each part 202d,e,f is tagged with the upload ID for the multipart upload and a unique part number to differentiate the respective parts from each other (e.g., ID, part 1; ID, part 2; . . . ; ID, part N). The cloud storage system 230 responds to the VCL 220 with a separate acknowledgement 202g,h,i for each part 202d,e,f received from the VCL 220 (e.g., ACK 1, ACK 2, . . . , ACK N). Upon receiving the acknowledgements 202g,h,i from the cloud storage system 230 for all part uploads 202d,e,f, the VCL 220 sends a multipart upload complete notification 202j to the cloud storage system 230 to indicate that all parts of the object have been uploaded, and the cloud storage system 230 responds to the VCL 220 with an acknowledgement 202k of the completed multipart upload. Once the cloud storage system 230 sends this acknowledgement 202k that the multipart upload is complete, subsequent requests can be sent to the cloud storage system 230 to access the uploaded object. Accordingly, the VCL 220 sends a write complete notification 202l to the application 220 to indicate that the object has been successfully uploaded and written to the cloud storage system 230.

While a multipart upload can improve the efficiency of an upload in some cases, it requires multiple roundtrips due to the additional signaling overhead, which increases the upload latency for the uploaded object. For example, three round trips are involved in the multipart upload of FIG. 2A. First, the initiate multipart upload request 202b is sent and the upload ID 202c is returned. Then, each part 202d,e,f is uploaded and acknowledgements 202g,h,i are returned upon completion of each part upload. Finally, the multipart upload complete notification 202j is sent and an acknowledgment is returned 202k.

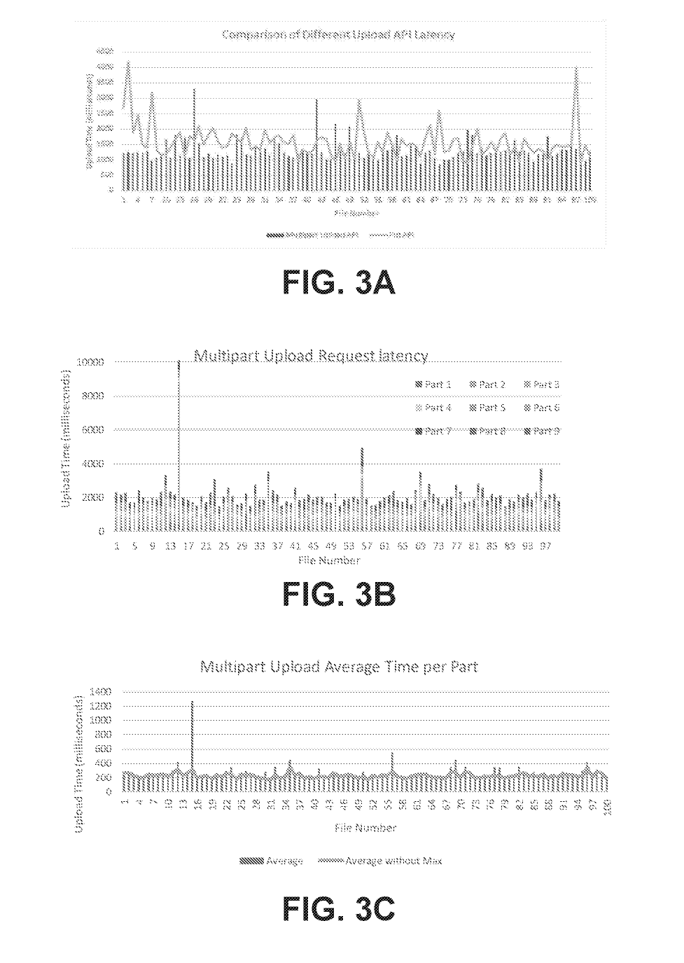

Thus, in some embodiments, due to the additional overhead required for multipart uploads (e.g., for the initialization and completion calls), the VCL 220 may upload small images using traditional methods (e.g., uploading an image in its entirety using a put API) while uploading large images using multipart uploads (e.g., uploading an image in multiple parallel parts to reduce latency). The benefits of this approach can be seen in the performance graph of FIG. 3A, which compares the upload latency for large files (e.g., multiple megabytes in size) when using multipart uploads versus whole object PUT requests. As shown in FIG. 3A, the upload latency for large files is lower when multipart uploads are used rather than whole object PUT requests.

FIGS. 2B-C illustrate call flow diagrams for an image write operation performed using a multipart upload with various techniques for reducing latency caused by part upload variability. For example, as shown in FIG. 3B, extensive measurements on multipart image upload operations demonstrate that some of the individual part uploads take a significantly longer time than others. In particular, FIG. 3B illustrates the latency of various multipart file uploads on a per-part basis, which demonstrates that large latency spikes occur at random during the upload of certain parts of the multipart uploads.

The parts that take longer to upload are completely random. This is expected behavior for a shared or cloud-based storage system 230, which is typically affected by a large number of variables, ranging from the cloud service provider's internal cluster behavior to the ambient load caused by requests from other tenants.

Due to these random latency spikes in a multipart upload, however, the latency of the entire image upload as seen by the application 210 is gated by the upload latency of the slowest part. This is problematic both due to the increased latency (which gates downstream application stage execution) as well as the variability (which is typically managed by costly resource overprovisioning). Thus, in some embodiments, a multipart upload may leverage various techniques to reduce the part upload variability that often occurs when using a shared storage system 230, as explained below in connection with FIGS. 2B-C.

FIG. 2B illustrates a call flow diagram 200B for an image write operation performed using a multipart upload with part retries. In some cases, for example, the VCL 220 may retry certain part uploads of a multipart upload if those part uploads do not complete within a certain amount of time, such as within a median upload time. For example, internally, the VCL 220 can maintain the median time taken for uploading a part, Tm. This median time Tm is used to set a timeout whenever a new part is uploaded. If the part upload does not complete within this time, the VCL 220 times out the part upload and retries uploading the same part again.

For example, the illustrated call flow of FIG. 2B is similar to that of FIG. 2A. However, the VCL 220 fails to receive an acknowledgment from the cloud storage system 230 for part two 202e of the multipart upload within the median part upload time Tm. Accordingly, after the expiration of the median part upload time Tm, the VCL 220 retries the upload of part two 202m, and upon successfully uploading part two 202m on the second try, the cloud storage system 230 responds to the VCL 220 with a corresponding acknowledgment 202h for part two.

This approach improves the overall latency of the write, as experiments demonstrate that retrying a part upload is much faster than simply waiting for the part upload that is taking unusually long to complete. For example, when using part retries, the upload time for all parts of a multipart upload in the event of a part timeout and retry is roughly twice the median part upload latency, or Tm*2 (e.g., Tm timeout latency+Tm part upload retry latency) at the cost of a slight increase in bandwidth consumed (e.g., since the VCL 220 sends the timed-out part data to the storage system 230 multiple times). For comparison, FIG. 3C illustrates a performance graph of the average per-part upload time for various multipart file uploads without using part retries. As shown in FIG. 3C, there are large spikes in the average part upload time for certain multipart uploads that experience a latency spike during the upload of one of the parts.

FIG. 2C illustrates a call flow diagram 200C for an image write operation performed using a multipart upload with redundant parallel part tries. In some cases, for example, the VCL 220 may upload multiple copies of each part of a multipart upload in parallel to reduce latency even further. The goal with this approach is to increase the probability that each part gets uploaded within the median part upload latency. For example, as explained above, certain parts of the multipart upload may randomly take much longer to upload than others. By sending each part multiple times in parallel, the probability increases that at least one copy of each part gets uploaded within the median part upload time.

For example, the illustrated call flow of FIG. 2C is similar to that of FIG. 2A. However, the VCL 220 uploads duplicate copies of each part 202n,o in parallel to the cloud storage system 230. As soon as at least one copy of each part is successfully uploaded, the completion messages 202j,k,l for the multipart upload can proceed.

While this approach comes with a cost of significantly higher bandwidth consumption (e.g., bandwidth consumption is doubled if two redundant copies are sent per part), it significantly reduces the probability of the entire multipart object upload being delayed due to a delay in a particular part upload. In other words, this approach trades higher bandwidth consumption for lower latency.

FIGS. 2D-E illustrate call flow diagrams for an image write operation with strong consistency guarantees. For example, cloud storage systems 230 typically offer “eventual consistency” for write operations, such that after a write is completed, the newly written data might not be visible in response to some requests from applications 210 for a short period of time. While some applications 210 can tolerate this (or are designed to handle this), others might desire strong consistency to guarantee that the newly written data is visible to all subsequent requests. Thus, in some cases, the VCL 220 may provide the flexibility for an application 210 to choose a desired level of consistency for a write operation.

For example, if the application 210 indicates that eventual consistency is acceptable, then the write operation may be performed using the call flow of FIG. 2A, such that the VCL 220 notifies the application 210 that the write operation is complete 202l as soon as the VCL 220 receives the acknowledgement 202k of the completed multipart upload 202j from the cloud storage system 230.

However, If the application 210 indicates that stronger consistency is desired, then the write operation may be performed using either of the call flows from FIGS. 2D-E, as explained further below.

FIG. 2D illustrates a call flow diagram 200D for an image write operation performed using a multipart upload that provides strong consistency. For example, when the underlying storage system 230 only offers eventual consistency for a write operation, one approach to ensure that the write operation is performed with strong consistency is to internally perform a synchronous read of the data that was just written. Once this read is completed successfully, only then is a notification sent to the application 210 indicating that the write operation is complete. This approach simplifies the application logic but comes at the price of high write latency.

For example, the illustrated call flow of FIG. 2D is similar to that of FIG. 2A. However, after the VCL 220 receives the acknowledgment 202k of the completed multipart upload 202j from the cloud storage system 230, the VCL 220 sends a read image request 202p to the cloud storage system 230, and the cloud storage system 230 responds with the corresponding image data 202q. In some embodiments, the VCL 220 may verify that the correct image data 202q was returned in response to the read request. Once the read completes successfully, at that point the image has been confirmed to be visible and accessible on the cloud storage system 230, and thus the VCL 220 sends a write complete notification 202l to the application 210.

FIG. 2E illustrates a call flow diagram 200E for an image write operation performed using a multipart upload with dual completion callbacks to balance consistency and latency. For example, for applications that desire both strong consistency and low latency, another approach is to provide a first callback notification after all part uploads are completed/acknowledged (e.g., before the image is guaranteed to be visible and accessible on the cloud storage system 230), and a second callback notification after the multipart upload is completed/acknowledged and the synchronous read of the image is completed successfully (e.g., indicating that the uploaded image data is visible and accessible to all subsequent readers and/or read requests).

This dual callback approach allows the uploading application 210 to free up the image data it holds sooner (e.g., upon receiving the first callback when the part uploads complete), while also being notified once the image is globally visible and accessible on the cloud storage system 230 (e.g., upon receiving the second callback when the read of the image has been performed successfully). In this manner, when the second callback is received, the uploading application 210 can update relevant metadata or send out a notification to downstream application stages indicating that the data is uploaded and ready for them to read. The net effect is reduced write latency as seen by uploading application 210, while preserving strong consistency for purposes of subsequent reads of the image.

For example, the illustrated call flow of FIG. 2E is similar to that of FIG. 2A. However, after the VCL 220 receives the acknowledgments 202g,h,i of the completed part uploads 202d,e,f from the cloud storage system 230, the VCL 220 sends an upload completion callback notification 202r to the application 210. Further, after the VCL 220 receives the acknowledgment 202k of the completed multipart upload 202j from the cloud storage system 230, the VCL 220 sends a read image request 202p to the cloud storage system 230, and the cloud storage system 230 responds with the corresponding image data 202q. In some embodiments, the VCL 220 may verify that the correct image data 202q was returned in response to the read request.

Once the read completes successfully, at that point the image has been confirmed to be visible and accessible on the cloud storage system 230, and thus the VCL 220 sends a write completion callback notification 202l to the application 210.

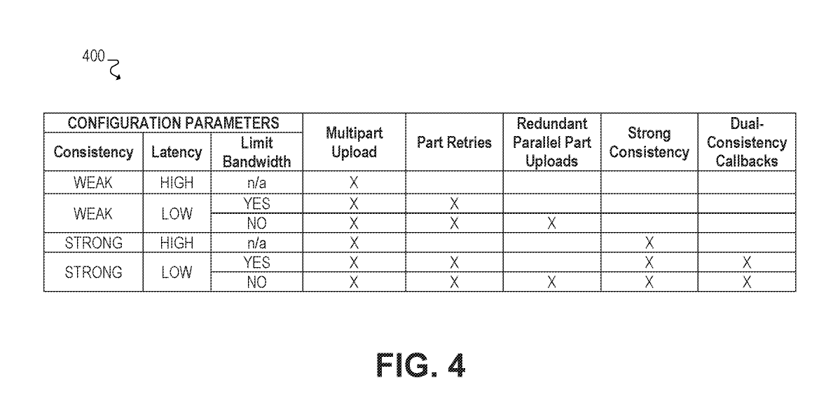

FIG. 4 illustrates an example implementation of an image write operation 400 with configurable quality of service (QoS) parameters. In some embodiments, for example, the image write operation 400 may be implemented by a visual compute library (VCL) that provides efficient storage and retrieval of visual data on behalf of visual computing applications. Moreover, the image write operation 400 may be capable of storing an image or other visual data on remote or centralized storage, such as a cloud storage system or service. Further, the VCL may enable a visual computing application to specify various quality of service (QoS) parameters that dictate how the write operation 400 is performed.

In particular, in the illustrated example, the VCL enables an application to specify QoS parameters relating to the desired consistency (e.g., weak, strong), latency (e.g., low, high), and/or bandwidth consumption (e.g., limited, not limited) for the write operation 400. Moreover, based on the configured values of these QoS parameters, the VCL may upload and write the visual data to remote storage using various techniques designed to maximize the performance preferences of the application. For example, based on the consistency, latency, and/or bandwidth parameters specified by the application, the VCL may perform the write operation 400 using one or more of the techniques described above in connection with FIGS. 2A-E, such as multipart uploads, part upload retries, redundant parallel part uploads, guaranteed consistency callbacks, and/or dual-consistency callbacks. An example of the behavior of the write operation 400 based on different values of the consistency, latency, and bandwidth parameters in shown in FIG. 4 and reproduced below in TABLE 1.

TABLE 1
Example behavior of an image write operation based on requested
consistency/latency/bandwidth

| CONFIGURATION | | | | | Redundant | | |
|---|---|---|---|---|---|---|---|
| PARAMETERS | | | | | Parallel | | |
| | | Limit | Multipart | Part | Part | Strong | Dual |
| Consistency | Latency | BW | Upload | Retries | Uploads | Consistency | Callbacks |
| WEAK | HIGH | n/a | X | | | | |
| WEAK | LOW | YES | X | X | | | |
| | | NO | X | X | X | | |
| STRONG | HIGH | n/a | X | | | X | |
| STRONG | LOW | YES | X | X | | X | X |
| | | NO | X | X | X | X | X |

As shown above in TABLE 1, the VCL performs the write operation using a multipart upload regardless of how the QoS parameters are configured. In other embodiments, however, the VCL may perform the write operation without using a multipart upload in certain circumstances, such as if the size of the image or visual data is relatively small, or if the application otherwise requests not to use a multipart upload. In such cases, a put API may be used to upload the image or visual data in its entirety (e.g., in a single upload).

If the consistency parameter is set to “WEAK” (e.g., consistency is not as important to the application), the VCL may notify the application that the write is complete once all parts have been uploaded, but before the data is necessarily globally visible or readable (e.g., similar to the call flow of FIG. 2A).

If the consistency parameter is set to “STRONG,” however, the VCL may notify the application that the write is complete only after confirming that the visual data can be successfully read from the remote storage system or service (e.g., similar to the call flow of FIG. 2D). In some embodiments, if the consistency parameter is not set by the application (and the latency parameter either is not set or is set to “HIGH”), the VCL may assume that the consistency parameter is set to “STRONG” by default.

If the latency parameter is set to “HIGH” (e.g., latency is not as important to the application), the VCL may perform the write operation using a multipart upload but without using part retries or redundant parallel part uploads. Moreover, in some embodiments, if the latency parameter is not set by the application, the VCL may assume that the latency parameter is set to “HIGH” by default.

If the latency parameter is set to “LOW” (e.g., low latency is important to the application), the VCL may perform the write operation using a multipart upload with part retries (e.g., similar to the call flow of FIG. 2B), and optionally also using redundant parallel part uploads (e.g., similar to the call flow of FIG. 2C) if the limit bandwidth parameter is set to “NO” (e.g., limiting bandwidth consumption is not important to the application). Moreover, in some embodiments, if the latency parameter is set to “LOW” and the consistency parameter is not set by the application, the VCL may assume that the consistency parameter is set to “WEAK” by default.

It is also possible for the application request both low latency and strong consistency. For example, if the latency parameter is set to “LOW” and the consistency parameter is set to “STRONG,” the VCL may perform the write operation using a multipart upload with part retries (e.g., similar to the call flow of FIG. 2B) to reduce latency (and optionally also using redundant parallel part uploads (e.g., similar to the call flow of FIG. 2C) if the limit bandwidth parameter is set to “NO”), along with dual completion callbacks to balance latency and consistency considerations (e.g., similar to the call flow of FIG. 2E). For example, using the dual completion callback approach, the application receives an initial callback notification when the data has been safely uploaded into the storage system (e.g., allowing the application to free any copy of the data it might be holding), and the application receives a subsequent callback notification indicating when the newly written data is globally readable (e.g., at which point the application can update metadata and/or otherwise notify other processing stages that the newly added data is available).

In various embodiments, the VCL may provide any suitable mechanism to enable the application to configure the consistency, latency, and/or bandwidth parameters for the write operation 400. In some embodiments, for example, the QoS parameters may be configured by the application via an application programming interface (API) implemented by the VCL. For example, when configuring a connection to the remote storage system, the application may choose to set one or more of the consistency, latency, and/or bandwidth parameters, which dictates how the VCL will handle the remote input/output (I/O) associated with the write operation 400. The following pseudocode illustrates an example of the QoS configuration mechanism for the image write operation 400:

```
class RemoteConnection {
    enum Consistency { WEAK, STRONG };
    enum Latency { LOW, HIGH };
    enum LimitBandwidth { YES, NO };
    RemoteConnection(Consistency const = STRONG,
Latency lat = LOW, LimitBandwidth bw = NO);
    set_consistency(Consistency const);
    set_latency(Latency lat);
    set_limitbandwidth(LimitBandwidth bw);
    ...
}
```

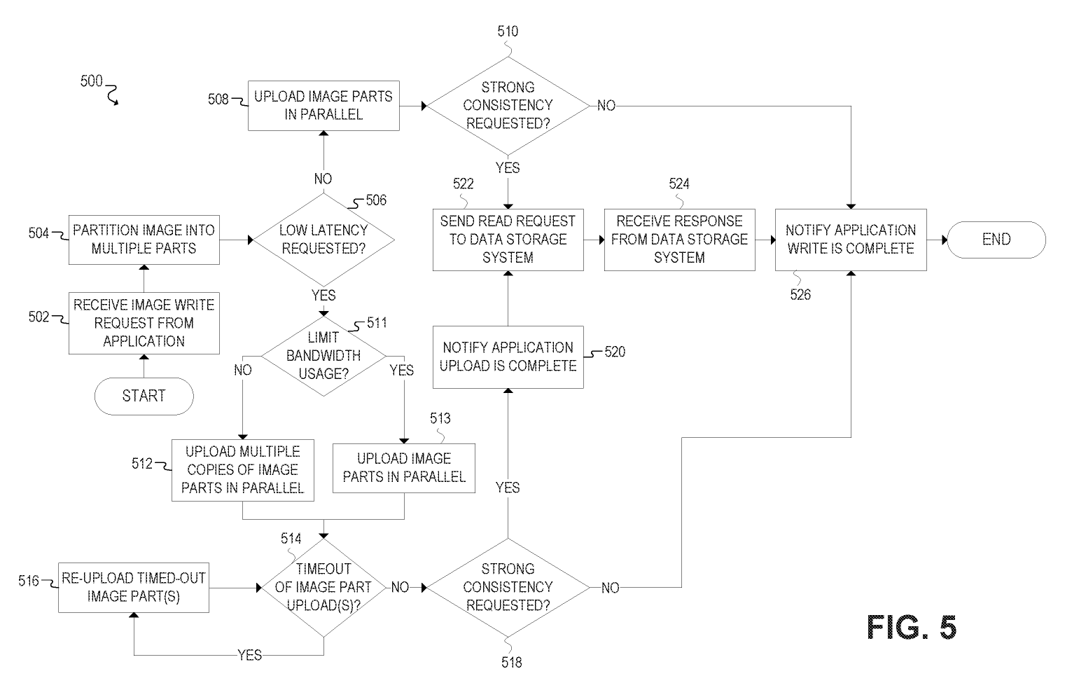

FIG. 5 illustrates a flowchart 500 for an example embodiment of an image write operation using configurable quality of service (QoS) parameters. In some cases, flowchart 500 may be implemented using the various embodiments and functionality described throughout this disclosure. For example, in some embodiments, flowchart 500 may be implemented by a visual compute library that provides efficient storage and retrieval of visual data on behalf of visual computing applications (e.g., visual compute library 160 of FIG. 1).

The flowchart begins at block 502, where an image write request is received from an application. In some cases, for example, the image write request may be a request from the application to write an image or other visual data to a remote storage system, such as a cloud-based storage service.

Moreover, the image write request may include one or more quality of service (QoS) parameters indicating a level of service requested by the application in connection with writing the image to the remote storage system. In some embodiments, for example, the QoS parameters may include a consistency parameter, a latency parameter, and/or a bandwidth parameter. The consistency parameter may indicate a requested write consistency level for writing the image to the remote storage system (e.g., strong consistency, weak consistency). The latency parameter may indicate a requested latency for uploading/writing the image to the remote storage system (e.g., low latency, high latency). The bandwidth parameter may indicate whether limited bandwidth consumption is requested by the application (e.g., yes, no). In other embodiments, however, the image write request may be implemented using any other type and/or combination of parameter(s) relating to quality of service and/or performance.

The flowchart then proceeds to block 504 to partition the image into multiple parts. In some embodiments, for example, an image may be uploaded to the remote storage system using a multipart upload. For example, the image may be partitioned into multiple parts that each contain a corresponding portion of the image, and the respective parts may be uploaded to the remote storage system in parallel (e.g., to reduce latency).

In other embodiments, a multipart upload may only be used if the size of the image exceeds a certain threshold size, such that large images are uploaded using multipart uploads while small images are uploaded in their entirety using a put API.

The flowchart then proceeds to block 506 to determine whether the application requested low latency for the write request. In some cases, for example, the application may have set the latency QoS parameter to “LOW” (or another equivalent value), indicating that low latency is preferred by the application for the write request.

If it is determined at block 506 that low latency was NOT requested by the application, the flowchart then proceeds to block 508 to upload the image to the remote storage system using a multipart upload. For example, the respective image parts (e.g., from block 504) may be uploaded in parallel to the remote storage system. Since low latency was not requested, only a single copy of each image part is uploaded to the remote storage system.

The flowchart then proceeds to block 510 to determine whether the application requested strong consistency for the write request. In some cases, for example, the application may have set the consistency QoS parameter to “STRONG” (or another equivalent value), indicating that strong consistency is preferred by the application for the write request.

If it is determined at block 510 that strong consistency was NOT requested by the application, the flowchart proceeds to block 526 to notify the application that the write is complete. For example, since the application did not request strong consistency, the application is notified that the write is complete once the image is successfully uploaded to the remote storage system (even though the image is not yet guaranteed to be visible or accessible on the remote storage system). At this point, the flowchart may be complete.

If it is determined at block 510 that strong consistency was requested by the application, the flowchart proceeds to block 522 to confirm that the image is accessible or readable on the remote storage system, as described below.

If it is determined at block 506 that low latency was requested by the application, the flowchart then proceeds to block 511 to determine whether the application requested to limit bandwidth consumption.

If it is determined at block 511 that the application requested to limit bandwidth consumption, the flowchart then proceeds to block 513 to upload the image to the remote storage system using a multipart upload with part retries. In particular, at block 513, a single copy of each image part is uploaded to the remote storage system in parallel (e.g., since limited bandwidth consumption was requested). The flowchart then proceeds to block 514 to perform retries of part uploads that timeout, as described further below.

If it is determined at block 511 that the application did not request to limit bandwidth consumption and/or requested unlimited bandwidth consumption, the flowchart then proceeds to block 512 to upload the image to the remote storage system using a multipart upload with redundant parallel part uploads and part retries. In particular, at block 512, multiple redundant copies of each image part are uploaded to the remote storage system in parallel (e.g., since limited bandwidth consumption was not requested). In some cases, for example, two copies of each image part may be uploaded to the remote storage system in parallel. The flowchart then proceeds to block 514 to perform retries of part uploads that timeout, as described further below.

At block 514, it is determined whether the uploads of any image parts timed out. In some embodiments, for example, if any of the image parts fail to upload within a particular upload timeout threshold, those parts may be re-uploaded to the remote storage system at the expiration of the upload timeout threshold rather than waiting on the pending uploads to complete. Moreover, in some embodiments, the upload timeout threshold may be defined using a median part upload time. For example, the median part upload time may be computed as the running median upload time for image part uploads associated with multiple images that have been written to the remote storage system in response to image write requests.

If it is determined at block 514 that one or more image part uploads have timed out, the flowchart then proceeds to block 516 to re-upload the image part(s) that timed out. The flowchart then proceeds back to block 514 and/or 516 in this manner until all image parts are successfully uploaded.

If it is determined at block 514 that none of the image part uploads have timed out, then all image parts have been successfully uploaded. The flowchart then proceeds to block 518 to determine whether the application requested strong consistency for the write request.

If it is determined at block 518 that strong consistency was NOT requested by the application, the flowchart proceeds to block 526 to notify the application that the write is complete. For example, since the application did not request strong consistency, the application is notified that the write is complete once the image is successfully uploaded to the remote storage system (even though the image is not yet guaranteed to be visible or accessible on the remote storage system). At this point, the flowchart may be complete.

If it is determined at block 518 that strong consistency was requested by the application, the flowchart proceeds to block 520 to notify the application that the upload is complete. For example, because both low latency and strong consistency were requested by the application, multiple notifications are provided to the application. The first notification is provided to the application when the upload is complete (block 520), while the second notification is provided to the application once the image is accessible or readable on the remote storage system (block 526). Thus, at block 520, the application is notified that the upload is complete.

The flowchart then proceeds to block 522 to confirm that the image is accessible or readable on the remote storage system. For example, at block 522, a request to read the image is sent to the remote storage system, and at block 524, a response to the read request is received from the remote storage system. If the read request was successful and the response from the remote storage system contains the image that was previously uploaded to the remote storage system, then the image has been confirmed to be accessible/readable on the remote storage system. Thus, the flowchart then proceeds to block 526 to notify the application that the write is complete (and/or that the image is accessible/readable on the remote storage system).

At this point, the flowchart may be complete. In some embodiments, however, the flowchart may restart and/or certain blocks may be repeated. For example, in some embodiments, the flowchart may restart at block 502 to continue receiving and processing image write requests from applications.

Example Internet-of-Things (IoT) Implementations

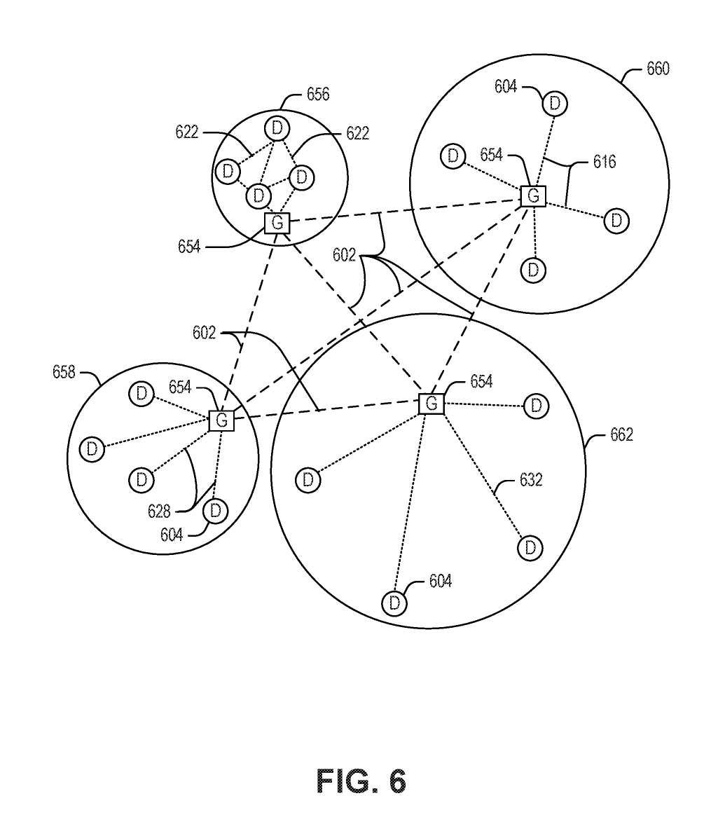

FIGS. 6-9 illustrate examples of Internet-of-Things (IoT) networks and devices that can be used in accordance with embodiments disclosed herein. For example, the operations and functionality described throughout this disclosure may be embodied by an IoT device or machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 6 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 6-9, present a number of new challenges in a heterogeneous network of connectivity comprising a combination of wired and wireless technologies.

FIG. 6 specifically provides a simplified drawing of a domain topology that may be used for a number of internet-of-things (IoT) networks comprising IoT devices 604, with the IoT networks 656, 658, 660, 662, coupled through backbone links 602 to respective gateways 654. For example, a number of IoT devices 604 may communicate with a gateway 654, and with each other through the gateway 654. To simplify the drawing, not every IoT device 604, or communications link (e.g., link 616, 622, 628, or 632) is labeled. The backbone links 602 may include any number of wired or wireless technologies, including optical networks, and may be part of a local area network (LAN), a wide area network (WAN), or the Internet. Additionally, such communication links facilitate optical signal paths among both IoT devices 604 and gateways 654, including the use of MUXing/deMUXing components that facilitate interconnection of the various devices.

The network topology may include any number of types of IoT networks, such as a mesh network provided with the network 656 using Bluetooth low energy (BLE) links 622. Other types of IoT networks that may be present include a wireless local area network (WLAN) network 658 used to communicate with IoT devices 604 through IEEE 802.11 (Wi-Fi®) links 628, a cellular network 660 used to communicate with IoT devices 604 through an LTE/LTE-A (4G) or 5G cellular network, and a low-power wide area (LPWA) network 662, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 604, such as over the backbone links 602, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 656, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 658, for instance, may use systems that perform standards conversion to provide multi-standard connectivity, enabling IoT devices 604 using different protocols to communicate. Further systems may provide seamless interconnectivity across a multi-standard infrastructure comprising visible Internet resources and hidden Internet resources.

Communications in the cellular network 660, for instance, may be enhanced by systems that offload data, extend communications to more remote devices, or both. The LPWA network 662 may include systems that perform non-Internet protocol (IP) to IP interconnections, addressing, and routing. Further, each of the IoT devices 604 may include the appropriate transceiver for wide area communications with that device. Further, each IoT device 604 may include other transceivers for communications using additional protocols and frequencies.

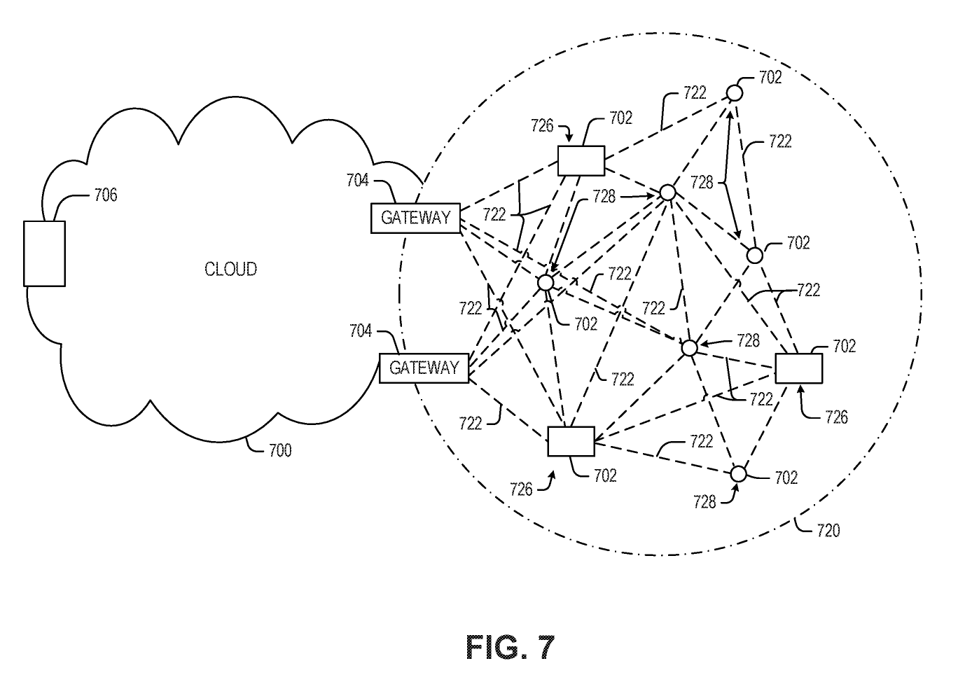

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 7 below.

FIG. 7 illustrates a cloud computing network in communication with a mesh network of IoT devices (devices 702) operating as a fog device at the edge of the cloud computing network. The mesh network of IoT devices may be termed a fog 720, operating at the edge of the cloud 700. To simplify the diagram, not every IoT device 702 is labeled.

The fog 720 may be considered to be a massively interconnected network wherein a number of IoT devices 702 are in communications with each other, for example, by radio links 722. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 702 are shown in this example, gateways 704, data aggregators 726, and sensors 728, although any combinations of IoT devices 702 and functionality may be used. The gateways 704 may be edge devices that provide communications between the cloud 700 and the fog 720, and may also provide the backend process function for data obtained from sensors 728, such as motion data, flow data, temperature data, and the like. The data aggregators 726 may collect data from any number of the sensors 728, and perform the back-end processing function for the analysis. The results, raw data, or both may be passed along to the cloud 700 through the gateways 704. The sensors 728 may be full IoT devices 702, for example, capable of both collecting data and processing the data. In some cases, the sensors 728 may be more limited in functionality, for example, collecting the data and allowing the data aggregators 726 or gateways 704 to process the data.

Communications from any IoT device 702 may be passed along a convenient path (e.g., a most convenient path) between any of the IoT devices 702 to reach the gateways 704. In these networks, the number of interconnections provide substantial redundancy, allowing communications to be maintained, even with the loss of a number of IoT devices 702. Further, the use of a mesh network may allow IoT devices 702 that are very low power or located at a distance from infrastructure to be used, as the range to connect to another IoT device 702 may be much less than the range to connect to the gateways 704.

The fog 720 provided from these IoT devices 702 may be presented to devices in the cloud 700, such as a server 706, as a single device located at the edge of the cloud 700, e.g., a fog device. In this example, the alerts coming from the fog device may be sent without being identified as coming from a specific IoT device 702 within the fog 720. In this fashion, the fog 720 may be considered a distributed platform that provides computing and storage resources to perform processing or data-intensive tasks such as data analytics, data aggregation, and machine-learning, among others.

In some examples, the IoT devices 702 may be configured using an imperative programming style, e.g., with each IoT device 702 having a specific function and communication partners. However, the IoT devices 702 forming the fog device may be configured in a declarative programming style, allowing the IoT devices 702 to reconfigure their operations and communications, such as to determine needed resources in response to conditions, queries, and device failures. As an example, a query from a user located at a server 706 about the operations of a subset of equipment monitored by the IoT devices 702 may result in the fog 720 device selecting the IoT devices 702, such as particular sensors 728, needed to answer the query. The data from these sensors 728 may then be aggregated and analyzed by any combination of the sensors 728, data aggregators 726, or gateways 704, before being sent on by the fog 720 device to the server 706 to answer the query. In this example, IoT devices 702 in the fog 720 may select the sensors 728 used based on the query, such as adding data from flow sensors or temperature sensors. Further, if some of the IoT devices 702 are not operational, other IoT devices 702 in the fog 720 device may provide analogous data, if available.

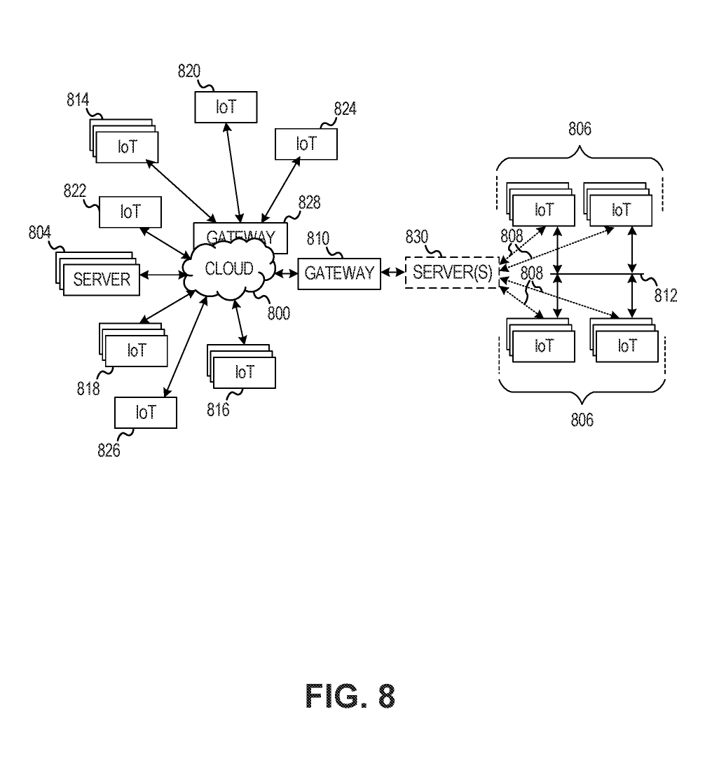

FIG. 8 illustrates a drawing of a cloud computing network, or cloud 800, in communication with a number of Internet of Things (IoT) devices. The cloud 800 may represent the Internet, or may be a local area network (LAN), or a wide area network (WAN), such as a proprietary network for a company. The IoT devices may include any number of different types of devices, grouped in various combinations. For example, a traffic control group 806 may include IoT devices along streets in a city. These IoT devices may include stoplights, traffic flow monitors, cameras, weather sensors, and the like. The traffic control group 806, or other subgroups, may be in communication with the cloud 800 through wired or wireless links 808, such as LPWA links, optical links, and the like. Further, a wired or wireless sub-network 812 may allow the IoT devices to communicate with each other, such as through a local area network, a wireless local area network, and the like. The IoT devices may use another device, such as a gateway 810 or 828 to communicate with remote locations such as the cloud 800; the IoT devices may also use one or more servers 830 to facilitate communication with the cloud 800 or with the gateway 810. For example, the one or more servers 830 may operate as an intermediate network node to support a local edge cloud or fog implementation among a local area network. Further, the gateway 828 that is depicted may operate in a cloud-to-gateway-to-many edge devices configuration, such as with the various IoT devices 814, 820, 824 being constrained or dynamic to an assignment and use of resources in the cloud 800.

Other example groups of IoT devices may include remote weather stations 814, local information terminals 816, alarm systems 818, automated teller machines 820, alarm panels 822, or moving vehicles, such as emergency vehicles 824 or other vehicles 826, among many others. Each of these IoT devices may be in communication with other IoT devices, with servers 804, with another IoT fog device or system (not shown, but depicted in FIG. 7), or a combination therein. The groups of IoT devices may be deployed in various residential, commercial, and industrial settings (including in both private or public environments).

As can be seen from FIG. 8, a large number of IoT devices may be communicating through the cloud 800. This may allow different IoT devices to request or provide information to other devices autonomously. For example, a group of IoT devices (e.g., the traffic control group 806) may request a current weather forecast from a group of remote weather stations 814, which may provide the forecast without human intervention. Further, an emergency vehicle 824 may be alerted by an automated teller machine 820 that a burglary is in progress. As the emergency vehicle 824 proceeds towards the automated teller machine 820, it may access the traffic control group 806 to request clearance to the location, for example, by lights turning red to block cross traffic at an intersection in sufficient time for the emergency vehicle 824 to have unimpeded access to the intersection.

Clusters of IoT devices, such as the remote weather stations 814 or the traffic control group 806, may be equipped to communicate with other IoT devices as well as with the cloud 800. This may allow the IoT devices to form an ad-hoc network between the devices, allowing them to function as a single device, which may be termed a fog device or system (e.g., as described above with reference to FIG. 7).

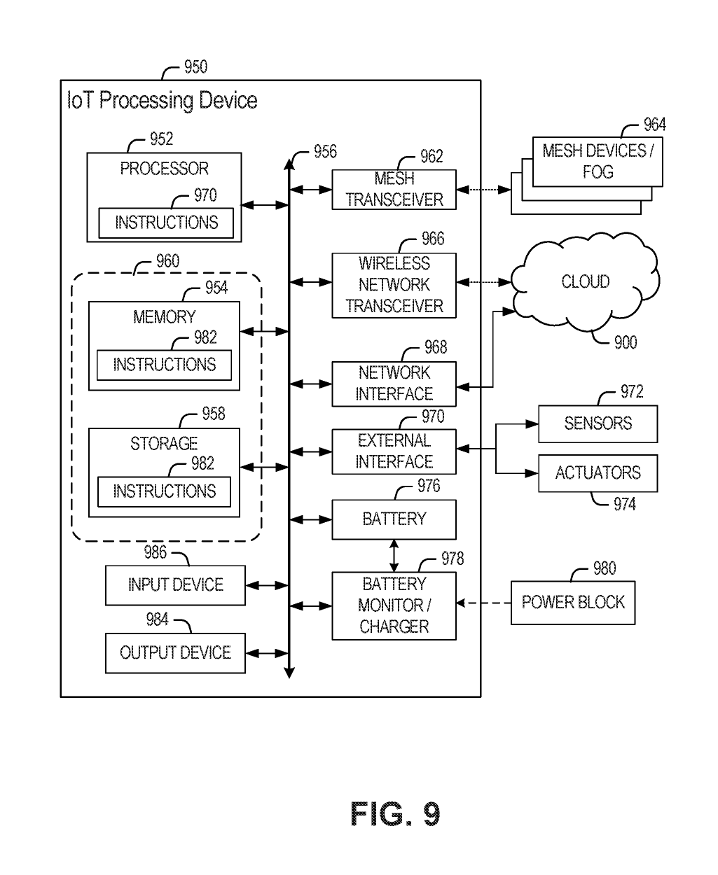

FIG. 9 is a block diagram of an example of components that may be present in an IoT device 950 for implementing the techniques described herein. The IoT device 950 may include any combinations of the components shown in the example or referenced in the disclosure above. The components may be implemented as ICs, portions thereof, discrete electronic devices, or other modules, logic, hardware, software, firmware, or a combination thereof adapted in the IoT device 950, or as components otherwise incorporated within a chassis of a larger system. Additionally, the block diagram of FIG. 9 is intended to depict a high-level view of components of the IoT device 950. However, some of the components shown may be omitted, additional components may be present, and different arrangement of the components shown may occur in other implementations.

The IoT device 950 may include a processor 952, which may be a microprocessor, a multi-core processor, a multithreaded processor, an ultra-low voltage processor, an embedded processor, or other known processing element. The processor 952 may be a part of a system on a chip (SoC) in which the processor 952 and other components are formed into a single integrated circuit, or a single package, such as the Edison™ or Galileo™ SoC boards from Intel. As an example, the processor 952 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 952 may communicate with a system memory 954 over an interconnect 956 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 958 may also couple to the processor 952 via the interconnect 956. In an example, the storage 958 may be implemented via a solid state disk drive (SSDD). Other devices that may be used for the storage 958 include flash memory cards, such as SD cards, microSD cards, xD picture cards, and the like, and USB flash drives. In low power implementations, the storage 958 may be on-die memory or registers associated with the processor 952. However, in some examples, the storage 958 may be implemented using a micro hard disk drive (HDD). Further, any number of new technologies may be used for the storage 958 in addition to, or instead of, the technologies described, such resistance change memories, phase change memories, holographic memories, or chemical memories, among others.

The components may communicate over the interconnect 956. The interconnect 956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in a SoC based system. Other bus systems may be included, such as an I2C interface, an SPI interface, point to point interfaces, and a power bus, among others.

The interconnect 956 may couple the processor 952 to a mesh transceiver 962, for communications with other mesh devices 964. The mesh transceiver 962 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 964. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 962 may communicate using multiple standards or radios for communications at different range. For example, the IoT device 950 may communicate with close devices, e.g., within about 10 meters, using a local transceiver based on BLE, or another low power radio, to save power. More distant mesh devices 964, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 966 may be included to communicate with devices or services in the cloud 900 via local or wide area network protocols. The wireless network transceiver 966 may be a LPWA transceiver that follows the IEEE 802.15.4, or IEEE 802.15.4g standards, among others. The IoT device 950 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 962 and wireless network transceiver 966, as described herein. For example, the radio transceivers 962 and 966 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 962 and 966 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology,

In addition to the standards listed above, any number of satellite uplink technologies may be used for the wireless network transceiver 966, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 968 may be included to provide a wired communication to the cloud 900 or to other devices, such as the mesh devices 964. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 968 may be included to allow connect to a second network, for example, a NIC 968 providing communications to the cloud over Ethernet, and a second NIC 968 providing communications to other devices over another type of network.

The interconnect 956 may couple the processor 952 to an external interface 970 that is used to connect external devices or subsystems. The external devices may include sensors 972, such as accelerometers, level sensors, flow sensors, optical light sensors, camera sensors, temperature sensors, a global positioning system (GPS) sensors, pressure sensors, barometric pressure sensors, and the like. The external interface 970 further may be used to connect the IoT device 950 to actuators 974, such as power switches, valve actuators, an audible sound generator, a visual warning device, and the like.

In some optional examples, various input/output (I/O) devices may be present within, or connected to, the IoT device 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 950.

A battery 976 may power the IoT device 950, although in examples in which the IoT device 950 is mounted in a fixed location, it may have a power supply coupled to an electrical grid. The battery 976 may be a lithium ion battery, or a metal-air battery, such as a zinc-air battery, an aluminum-air battery, a lithium-air battery, and the like.

A battery monitor/charger 978 may be included in the IoT device 950 to track the state of charge (SoCh) of the battery 976. The battery monitor/charger 978 may be used to monitor other parameters of the battery 976 to provide failure predictions, such as the state of health (SoH) and the state of function (SoF) of the battery 976. The battery monitor/charger 978 may include a battery monitoring integrated circuit, such as an LTC4020 or an LTC2790 from Linear Technologies, an ADT7488A from ON Semiconductor of Phoenix Arizona, or an IC from the UCD90xxx family from Texas Instruments of Dallas, Tex. The battery monitor/charger 978 may communicate the information on the battery 976 to the processor 952 over the interconnect 956. The battery monitor/charger 978 may also include an analog-to-digital (ADC) convertor that allows the processor 952 to directly monitor the voltage of the battery 976 or the current flow from the battery 976. The battery parameters may be used to determine actions that the IoT device 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the IoT device 950. A wireless battery charging circuit, such as an LTC4020 chip from Linear Technologies of Milpitas, Calif., among others, may be included in the battery monitor/charger 978. The specific charging circuits chosen depend on the size of the battery 976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application specific integrated circuit (ASIC).

In an example, the instructions 982 provided via the memory 954, the storage 958, or the processor 952 may be embodied as a non-transitory, machine readable medium 960 including code to direct the processor 952 to perform electronic operations in the IoT device 950. The processor 952 may access the non-transitory, machine readable medium 960 over the interconnect 956. For instance, the non-transitory, machine readable medium 960 may include storage units such as optical disks, flash drives, or any number of other hardware devices. The non-transitory, machine readable medium 960 may include instructions to direct the processor 952 to perform a specific sequence or flow of actions, for example, as described with respect to the flowchart(s) and diagram(s) of operations and functionality described throughout this disclosure.

Example Computing Architectures

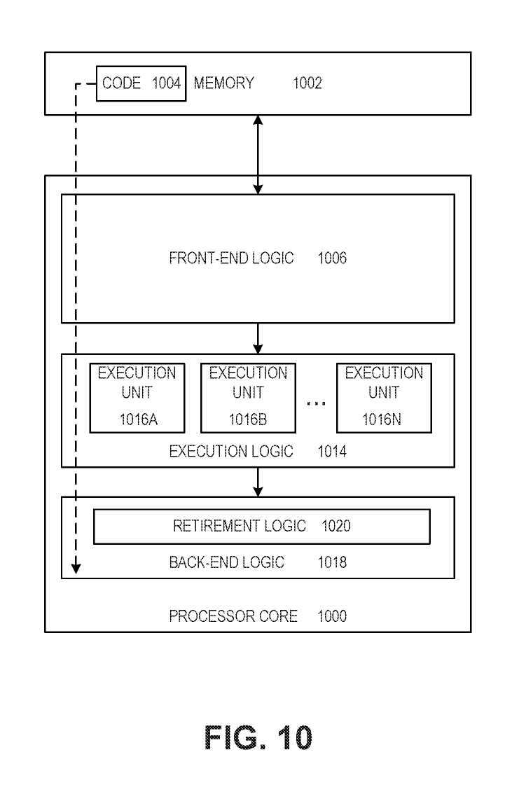

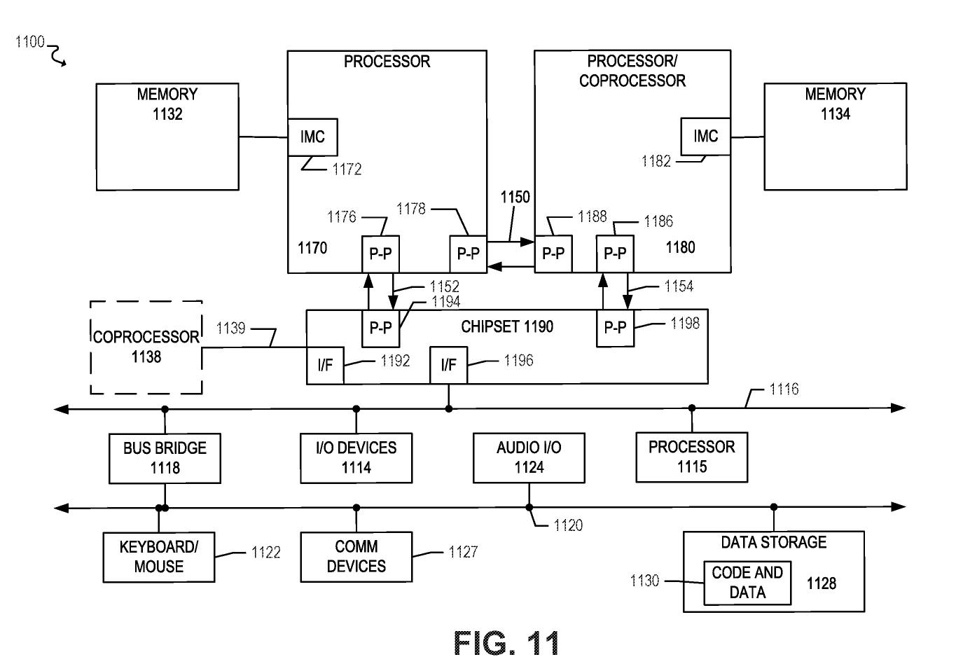

FIGS. 10 and 11 illustrate example computer processor architectures that can be used in accordance with embodiments disclosed herein. For example, in various embodiments, the computer architectures of FIGS. 10 and 11 may be used to implement the functionality described throughout this disclosure. Other embodiments may use other processor and system designs and configurations known in the art, for example, for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

FIG. 10 illustrates a block diagram for an example embodiment of a processor 1000. Processor 1000 is an example of a type of hardware device that can be used in connection with the embodiments described throughout this disclosure. Processor 1000 may be any type of processor, such as a microprocessor, an embedded processor, a digital signal processor (DSP), a network processor, a multi-core processor, a single core processor, or other device to execute code. Although only one processor 1000 is illustrated in FIG. 10, a processing element may alternatively include more than one of processor 1000 illustrated in FIG. 10. Processor 1000 may be a single-threaded core or, for at least one embodiment, the processor 1000 may be multi-threaded in that it may include more than one hardware thread context (or “logical processor”) per core.

FIG. 10 also illustrates a memory 1002 coupled to processor 1000 in accordance with an embodiment. Memory 1002 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1000 can execute any type of instructions associated with algorithms, processes, or operations detailed herein. Generally, processor 1000 can transform an element or an article (e.g., data) from one state or thing to another state or thing.

Code 1004, which may be one or more instructions to be executed by processor 1000, may be stored in memory 1002, or may be stored in software, hardware, firmware, or any suitable combination thereof, or in any other internal or external component, device, element, or object where appropriate and based on particular needs. In one example, processor 1000 can follow a program sequence of instructions indicated by code 1004. Each instruction enters a front-end logic 1006 and is processed by one or more decoders 1008. The decoder may generate, as its output, a micro operation such as a fixed width micro operation in a predefined format, or may generate other instructions, microinstructions, or control signals that reflect the original code instruction. Front-end logic 1006 may also include register renaming logic and scheduling logic, which generally allocate resources and queue the operation corresponding to the instruction for execution.

Processor 1000 can also include execution logic 1014 having a set of execution units 1016a, 1016b, 1016n, etc. Some embodiments may include a number of execution units dedicated to specific functions or sets of functions. Other embodiments may include only one execution unit or one execution unit that can perform a particular function. Execution logic 1014 performs the operations specified by code instructions.

After completion of execution of the operations specified by the code instructions, back-end logic 1018 can retire the instructions of code 1004. In one embodiment, processor 1000 allows out of order execution but requires in order retirement of instructions. Retirement logic 1020 may take a variety of known forms (e.g., re-order buffers or the like). In this manner, processor 1000 is transformed during execution of code 1004, at least in terms of the output generated by the decoder, hardware registers and tables utilized by register renaming logic 1010, and any registers (not shown) modified by execution logic 1014.

Although not shown in FIG. 10, a processing element may include other elements on a chip with processor 1000. For example, a processing element may include memory control logic along with processor 1000. The processing element may include I/O control logic and/or may include I/O control logic integrated with memory control logic. The processing element may also include one or more caches. In some embodiments, non-volatile memory (such as flash memory or fuses) may also be included on the chip with processor 1000.

FIG. 11 illustrates a block diagram for an example embodiment of a multiprocessor 1100. As shown in FIG. 11, multiprocessor system 1100 is a point-to-point interconnect system, and includes a first processor 1170 and a second processor 1180 coupled via a point-to-point interconnect 1150. In some embodiments, each of processors 1170 and 1180 may be some version of processor 1000 of FIG. 10.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, matrix processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of this disclosure is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), matrix processors, field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

All or part of any component of FIG. 11 may be implemented as a separate or stand-alone component or chip, or may be integrated with other components or chips, such as a system-on-a-chip (SoC) that integrates various computer components into a single chip.

Embodiments of the mechanisms disclosed herein may be implemented in hardware, software, firmware, or a combination of such implementation approaches. Certain embodiments may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of this disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

The machine-readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein. In another example, the machine-readable instructions may be stored in a state in which they may be read by a computer, but require addition of a library (e.g., a dynamic link library), a software development kit (SDK), an application programming interface (API), etc. in order to execute the instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine readable instructions and/or program(s) when stored or otherwise at rest or in transit.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing disclosure outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

As used throughout this specification, the term “processor” or “microprocessor” should be understood to include not only a traditional microprocessor (such as Intel's® industry-leading x86 and x64 architectures), but also graphics processors, matrix processors, and any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

Note also that in certain embodiments, some of the components may be omitted or consolidated. In a general sense, the arrangements depicted in the figures should be understood as logical divisions, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute instructions associated with data or microcode to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), or microcode), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor to perform the disclosed operations. A non-transitory storage medium also expressly includes a processor having stored thereon hardware-coded instructions, and optionally microcode instructions or sequences encoded in hardware, firmware, or software.

Computer program logic implementing all or part of the functionality described herein is embodied in various forms, including, but in no way limited to, hardware description language, a source code form, a computer executable form, machine instructions or microcode, programmable hardware, and various intermediate forms (for example, forms generated by an HDL processor, assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

Example Implementations

The following examples pertain to embodiments described throughout this disclosure.

One or more embodiments may include an apparatus, comprising: a communication interface to communicate with a data storage system over a network; and processing circuitry to: receive a request from an application to write an image to the data storage system, wherein the request comprises one or more quality of service parameters indicating a level of service requested by the application for writing the image to the data storage system; partition the image into a plurality of image parts, wherein each image part of the plurality of image parts comprises a corresponding portion of the image; upload, via the communication interface, the plurality of image parts to the data storage system in parallel, wherein if the one or more quality of service parameters indicate that the level of service requested by the application comprises low latency: a plurality of redundant copies of each image part of the plurality of image parts is to be uploaded to the data storage system in parallel; and each image part of the plurality of image parts that fails to upload within an upload timeout threshold is to be re-uploaded to the data storage system after expiration of the upload timeout threshold; receive, via the communication interface, an acknowledgment from the data storage system that each image part of the plurality of image parts has been uploaded; and notify the application that the image has been written to the data storage system.

In one example embodiment of an apparatus, the processing circuitry to upload, via the communication interface, the plurality of image parts to the data storage system in parallel is further to: determine, based on the one or more quality of service parameters, that the level of service requested by the application comprises low latency; and based at least in part on determining that the level of service requested by the application comprises low latency: determine that one or more image parts of the plurality of image parts fail to upload within the upload timeout threshold; and re-upload, via the communication interface, the one or more image parts to the data storage system after expiration of the upload timeout threshold.

In one example embodiment of an apparatus, the upload timeout threshold comprises a median part upload time, wherein the median part upload time is computed based on a median upload time for a plurality of uploaded image parts associated with a plurality of images written to the data storage system.

In one example embodiment of an apparatus, the processing circuitry to upload, via the communication interface, the plurality of image parts to the data storage system in parallel is further to: determine, based on the one or more quality of service parameters, that the level of service requested by the application comprises low latency; and based at least in part on determining that the level of service requested by the application comprises low latency, upload the plurality of redundant copies of each image part to the data storage system in parallel.

In one example embodiment of an apparatus, the plurality of redundant copies comprises two copies of each image part of the plurality of image parts.

In one example embodiment of an apparatus, the processing circuitry to upload, via the communication interface, the plurality of image parts to the data storage system in parallel is further to: determine, based on the one or more quality of service parameters, that the level of service requested by the application further comprises unlimited bandwidth consumption; and based at least in part on determining that the level of service requested by the application comprises low latency and unlimited bandwidth consumption, upload the plurality of redundant copies of each image part to the data storage system in parallel.

In one example embodiment of an apparatus, the processing circuitry to notify the application that the image has been written to the data storage system is further to: determine, based on the one or more quality of service parameters, that the level of service requested by the application comprises strong consistency; and based at least in part on determining that the level of service requested by the application comprises strong consistency: send, via the communication interface, a read request to the data storage system, wherein the read request comprises a request to read the image from the data storage system; receive, via the communication interface, a response to the read request from the data storage system, wherein the response to the read request comprises the image; and upon receiving the response to the read request from the data storage system, notify the application that the image is accessible on the data storage system.

In one example embodiment of an apparatus, the processing circuitry to notify the application that the image has been written to the data storage system is further to: determine, based on the one or more quality of service parameters, that the level of service requested by the application further comprises low latency; and based at least in part on determining that the level of service requested by the application comprises strong consistency and low latency: upon receiving the acknowledgment from the data storage system that each image part of the plurality of image parts has been uploaded, notify the application that the image has been uploaded to the data storage system.

In one example embodiment of an apparatus, the one or more quality of service parameters comprise a latency parameter and a consistency parameter, wherein: the latency parameter indicates a requested latency for uploading the image to the data storage system; and the consistency parameter indicates a requested write consistency level for writing the image to the data storage system.

In one example embodiment of an apparatus, the data storage system comprises a cloud-based storage service.

One or more embodiments may include at least one non-transitory machine accessible storage medium having instructions stored thereon, wherein the instructions, when executed on a machine, cause the machine to: receive a request from an application to write an image to a data storage system, wherein the request comprises one or more quality of service parameters indicating a level of service requested by the application for writing the image to the data storage system; partition the image into a plurality of image parts, wherein each image part of the plurality of image parts comprises a corresponding portion of the image; upload, via a communication interface, the plurality of image parts to the data storage system in parallel, wherein if the one or more quality of service parameters indicate that the level of service requested by the application comprises low latency: a plurality of redundant copies of each image part of the plurality of image parts is to be uploaded to the data storage system in parallel; and each image part of the plurality of image parts that fails to upload within an upload timeout threshold is to be re-uploaded to the data storage system after expiration of the upload timeout threshold; receive, via the communication interface, an acknowledgment from the data storage system that each image part of the plurality of image parts has been uploaded; and notify the application that the image has been written to the data storage system.

In one example embodiment of a storage medium, the instructions that cause the machine to upload, via the communication interface, the plurality of image parts to the data storage system in parallel further cause the machine to: determine, based on the one or more quality of service parameters, that the level of service requested by the application comprises low latency; and based at least in part on determining that the level of service requested by the application comprises low latency: determine that one or more image parts of the plurality of image parts fail to upload within the upload timeout threshold; and re-upload, via the communication interface, the one or more image parts to the data storage system after expiration of the upload timeout threshold.

In one example embodiment of a storage medium, the upload timeout threshold comprises a median part upload time, wherein the median part upload time is computed based on a median upload time for a plurality of uploaded image parts associated with a plurality of images written to the data storage system.

In one example embodiment of a storage medium, the instructions that cause the machine to upload, via the communication interface, the plurality of image parts to the data storage system in parallel further cause the machine to: determine, based on the one or more quality of service parameters, that the level of service requested by the application comprises low latency; and based at least in part on determining that the level of service requested by the application comprises low latency, upload the plurality of redundant copies of each image part to the data storage system in parallel.

In one example embodiment of a storage medium, the instructions that cause the machine to notify the application that the image has been written to the data storage system further cause the machine to: determine, based on the one or more quality of service parameters, that the level of service requested by the application comprises strong consistency; and based at least in part on determining that the level of service requested by the application comprises strong consistency: send, via the communication interface, a read request to the data storage system, wherein the read request comprises a request to read the image from the data storage system; receive, via the communication interface, a response to the read request from the data storage system, wherein the response to the read request comprises the image; and upon receiving the response to the read request from the data storage system, notify the application that the image is accessible on the data storage system.

In one example embodiment of a storage medium, the instructions that cause the machine to notify the application that the image has been written to the data storage system further cause the machine to: determine, based on the one or more quality of service parameters, that the level of service requested by the application further comprises low latency; and based at least in part on determining that the level of service requested by the application comprises strong consistency and low latency: upon receiving the acknowledgment from the data storage system that each image part of the plurality of image parts has been uploaded, notify the application that the image has been uploaded to the data storage system.

One or more embodiments may include a method, comprising: receiving a request from an application to write an image to a data storage system, wherein the request comprises one or more quality of service parameters indicating a level of service requested by the application for writing the image to the data storage system; partitioning the image into a plurality of image parts, wherein each image part of the plurality of image parts comprises a corresponding portion of the image; uploading, via a communication interface, the plurality of image parts to the data storage system in parallel, wherein if the one or more quality of service parameters indicate that the level of service requested by the application comprises low latency: a plurality of redundant copies of each image part of the plurality of image parts is uploaded to the data storage system in parallel; and each image part of the plurality of image parts that fails to upload within an upload timeout threshold is re-uploaded to the data storage system after expiration of the upload timeout threshold; receiving, via the communication interface, an acknowledgment from the data storage system that each image part of the plurality of image parts has been uploaded; and notifying the application that the image has been written to the data storage system.

In one example embodiment of a method, uploading, via the communication interface, the plurality of image parts to the data storage system in parallel comprises: determining, based on the one or more quality of service parameters, that the level of service requested by the application comprises low latency; and based at least in part on determining that the level of service requested by the application comprises low latency: determining that one or more image parts of the plurality of image parts fail to upload within the upload timeout threshold; and re-uploading, via the communication interface, the one or more image parts to the data storage system after expiration of the upload timeout threshold.

In one example embodiment of a method, uploading, via the communication interface, the plurality of image parts to the data storage system in parallel comprises: determining, based on the one or more quality of service parameters, that the level of service requested by the application comprises low latency; and based at least in part on determining that the level of service requested by the application comprises low latency, uploading the plurality of redundant copies of each image part to the data storage system in parallel.

In one example embodiment of a method, notifying the application that the image has been written to the data storage system comprises: determining, based on the one or more quality of service parameters, that the level of service requested by the application comprises strong consistency; and based at least in part on determining that the level of service requested by the application comprises strong consistency: sending, via the communication interface, a read request to the data storage system, wherein the read request comprises a request to read the image from the data storage system; receiving, via the communication interface, a response to the read request from the data storage system, wherein the response to the read request comprises the image; and upon receiving the response to the read request from the data storage system, notifying the application that the image is accessible on the data storage system.

In one example embodiment of a method, notifying the application that the image has been written to the data storage system further comprises: determining, based on the one or more quality of service parameters, that the level of service requested by the application further comprises low latency; and based at least in part on determining that the level of service requested by the application comprises strong consistency and low latency: upon receiving the acknowledgment from the data storage system that each image part of the plurality of image parts has been uploaded, notifying the application that the image has been uploaded to the data storage system.

What is claimed is:

1. An apparatus, comprising:
a communication interface to communicate with a data storage system over a network; and
processing circuitry to:
receive a request from an application to write an image to the data storage system, wherein the request comprises one or more quality of service parameters indicating a level of service requested by the application for writing the image to the data storage system;
partition the image into a plurality of image parts, wherein each image part of the plurality of image parts comprises a corresponding portion of the image;
upload, via the communication interface, the plurality of image parts to the data storage system in parallel, wherein if the one or more quality of service parameters indicate that the level of service requested by the application comprises low latency:
a plurality of redundant copies of each image part of the plurality of image parts is to be uploaded to the data storage system in parallel; and
each image part of the plurality of image parts that fails to upload within an upload timeout threshold is to be re-uploaded to the data storage system after expiration of the upload timeout threshold;
receive, via the communication interface, an acknowledgment from the data storage system that each image part of the plurality of image parts has been uploaded; and
notify the application that the image has been written to the data storage system.

2. The apparatus of claim 1, wherein the processing circuitry to upload, via the communication interface, the plurality of image parts to the data storage system in parallel is further to:
determine, based on the one or more quality of service parameters, that the level of service requested by the application comprises low latency; and
based at least in part on determining that the level of service requested by the application comprises low latency:
determine that one or more image parts of the plurality of image parts fail to upload within the upload timeout threshold; and
re-upload, via the communication interface, the one or more image parts to the data storage system after expiration of the upload timeout threshold.

3. The apparatus of claim 1, wherein the upload timeout threshold comprises a median part upload time, wherein the median part upload time is computed based on a median upload time for a plurality of uploaded image parts associated with a plurality of images written to the data storage system.

4. The apparatus of claim 1, wherein the processing circuitry to upload, via the communication interface, the plurality of image parts to the data storage system in parallel is further to:
determine, based on the one or more quality of service parameters, that the level of service requested by the application comprises low latency; and
based at least in part on determining that the level of service requested by the application comprises low latency, upload the plurality of redundant copies of each image part to the data storage system in parallel.

5. The apparatus of claim 4, wherein the plurality of redundant copies comprises two copies of each image part of the plurality of image parts.

6. The apparatus of claim 4, wherein the processing circuitry to upload, via the communication interface, the plurality of image parts to the data storage system in parallel is further to:
determine, based on the one or more quality of service parameters, that the level of service requested by the application further comprises unlimited bandwidth consumption; and
based at least in part on determining that the level of service requested by the application comprises low latency and unlimited bandwidth consumption, upload the plurality of redundant copies of each image part to the data storage system in parallel.

7. The apparatus of claim 1, wherein the processing circuitry to notify the application that the image has been written to the data storage system is further to:
determine, based on the one or more quality of service parameters, that the level of service requested by the application comprises strong consistency; and
based at least in part on determining that the level of service requested by the application comprises strong consistency:
send, via the communication interface, a read request to the data storage system, wherein the read request comprises a request to read the image from the data storage system;
receive, via the communication interface, a response to the read request from the data storage system, wherein the response to the read request comprises the image; and
upon receiving the response to the read request from the data storage system, notify the application that the image is accessible on the data storage system.

8. The apparatus of claim 7, wherein the processing circuitry to notify the application that the image has been written to the data storage system is further to:
determine, based on the one or more quality of service parameters, that the level of service requested by the application further comprises low latency; and
based at least in part on determining that the level of service requested by the application comprises strong consistency and low latency:
upon receiving the acknowledgment from the data storage system that each image part of the plurality of image parts has been uploaded, notify the application that the image has been uploaded to the data storage system.

9. The apparatus of claim 1, wherein the one or more quality of service parameters comprise a latency parameter and a consistency parameter, wherein:
the latency parameter indicates a requested latency for uploading the image to the data storage system; and
the consistency parameter indicates a requested write consistency level for writing the image to the data storage system.

10. The apparatus of claim 1, wherein the data storage system comprises a cloud-based storage service.

11. At least one non-transitory machine accessible storage medium having instructions stored thereon, wherein the instructions, when executed on a machine, cause the machine to:
receive a request from an application to write an image to a data storage system, wherein the request comprises one or more quality of service parameters indicating a level of service requested by the application for writing the image to the data storage system;
partition the image into a plurality of image parts, wherein each image part of the plurality of image parts comprises a corresponding portion of the image;
upload, via a communication interface, the plurality of image parts to the data storage system in parallel, wherein if the one or more quality of service parameters indicate that the level of service requested by the application comprises low latency:
a plurality of redundant copies of each image part of the plurality of image parts is to be uploaded to the data storage system in parallel; and
each image part of the plurality of image parts that fails to upload within an upload timeout threshold is to be re-uploaded to the data storage system after expiration of the upload timeout threshold;
receive, via the communication interface, an acknowledgment from the data storage system that each image part of the plurality of image parts has been uploaded; and
notify the application that the image has been written to the data storage system.

12. The storage medium of claim 11, wherein the instructions that cause the machine to upload, via the communication interface, the plurality of image parts to the data storage system in parallel further cause the machine to:
determine, based on the one or more quality of service parameters, that the level of service requested by the application comprises low latency; and
based at least in part on determining that the level of service requested by the application comprises low latency:
determine that one or more image parts of the plurality of image parts fail to upload within the upload timeout threshold; and
re-upload, via the communication interface, the one or more image parts to the data storage system after expiration of the upload timeout threshold.

13. The storage medium of claim 11, wherein the upload timeout threshold comprises a median part upload time, wherein the median part upload time is computed based on a median upload time for a plurality of uploaded image parts associated with a plurality of images written to the data storage system.

14. The storage medium of claim 11, wherein the instructions that cause the machine to upload, via the communication interface, the plurality of image parts to the data storage system in parallel further cause the machine to:
determine, based on the one or more quality of service parameters, that the level of service requested by the application comprises low latency; and
based at least in part on determining that the level of service requested by the application comprises low latency, upload the plurality of redundant copies of each image part to the data storage system in parallel.

15. The storage medium of claim 11, wherein the instructions that cause the machine to notify the application that the image has been written to the data storage system further cause the machine to:
determine, based on the one or more quality of service parameters, that the level of service requested by the application comprises strong consistency; and
based at least in part on determining that the level of service requested by the application comprises strong consistency:
send, via the communication interface, a read request to the data storage system, wherein the read request comprises a request to read the image from the data storage system;
receive, via the communication interface, a response to the read request from the data storage system, wherein the response to the read request comprises the image; and
upon receiving the response to the read request from the data storage system, notify the application that the image is accessible on the data storage system.

16. The storage medium of claim 15, wherein the instructions that cause the machine to notify the application that the image has been written to the data storage system further cause the machine to:
determine, based on the one or more quality of service parameters, that the level of service requested by the application further comprises low latency; and
based at least in part on determining that the level of service requested by the application comprises strong consistency and low latency:
upon receiving the acknowledgment from the data storage system that each image part of the plurality of image parts has been uploaded, notify the application that the image has been uploaded to the data storage system.

17. A method, comprising:
receiving a request from an application to write an image to a data storage system, wherein the request comprises one or more quality of service parameters indicating a level of service requested by the application for writing the image to the data storage system;
partitioning the image into a plurality of image parts, wherein each image part of the plurality of image parts comprises a corresponding portion of the image;
uploading, via a communication interface, the plurality of image parts to the data storage system in parallel, wherein if the one or more quality of service parameters indicate that the level of service requested by the application comprises low latency:
a plurality of redundant copies of each image part of the plurality of image parts is uploaded to the data storage system in parallel; and
each image part of the plurality of image parts that fails to upload within an upload timeout threshold is re-uploaded to the data storage system after expiration of the upload timeout threshold;
receiving, via the communication interface, an acknowledgment from the data storage system that each image part of the plurality of image parts has been uploaded; and
notifying the application that the image has been written to the data storage system.

18. The method of claim 17, wherein uploading, via the communication interface, the plurality of image parts to the data storage system in parallel comprises:
determining, based on the one or more quality of service parameters, that the level of service requested by the application comprises low latency; and
based at least in part on determining that the level of service requested by the application comprises low latency:
uploading the plurality of redundant copies of each image part to the data storage system in parallel;
determining that one or more image parts of the plurality of image parts fail to upload within the upload timeout threshold; and
re-uploading, via the communication interface, the one or more image parts to the data storage system after expiration of the upload timeout threshold.

19. The method of claim 17, wherein notifying the application that the image has been written to the data storage system comprises:
determining, based on the one or more quality of service parameters, that the level of service requested by the application comprises strong consistency; and
based at least in part on determining that the level of service requested by the application comprises strong consistency:
sending, via the communication interface, a read request to the data storage system, wherein the read request comprises a request to read the image from the data storage system;
receiving, via the communication interface, a response to the read request from the data storage system, wherein the response to the read request comprises the image; and
upon receiving the response to the read request from the data storage system, notifying the application that the image is accessible on the data storage system.

20. The method of claim 19, wherein notifying the application that the image has been written to the data storage system further comprises:
determining, based on the one or more quality of service parameters, that the level of service requested by the application further comprises low latency; and
based at least in part on determining that the level of service requested by the application comprises strong consistency and low latency:
upon receiving the acknowledgment from the data storage system that each image part of the plurality of image parts has been uploaded, notifying the application that the image has been uploaded to the data storage system.
